(19) United States
(12) Patent Application Publication
(10) Pub. No.: US 2006/0224390 A1
(43) Pub. Date: Oct. 5, 2006

(54) System, method, and apparatus for audio decoding accelerator

(76) Inventors: Ramadas Lakshmikanth Pai, Bangalore (IN); Jagannath Sathyanarayana Shastry, Bangalore (IN); Ravindra Bidnur, Bangalore (IN)

Correspondence Address: MCANDREWS HELD & MALLOY, LTD, 500 WEST MADISON STREET, SUITE 3400, CHICAGO, IL, 60661, US

(21) Appl. No.: 11/096,653

(22) Filed: Apr. 1, 2005

(51) Int. Cl. G10L 13/06

(52) U.S. Cl. 704/268; 704/241

(57) ABSTRACT

Presented herein are system(s), method(s), and apparatus for an audio decoding accelerator. In one embodiment, there is presented an audio decoder for decoding audio data. The audio decoder comprises a controller and a computation engine. The controller receives the audio data, and provides parameters, where the parameters are associated with the audio data. The computation engine calculates at least one of a plurality of predetermined functions for said parameters.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The encoding and decoding of audio data involves the calculation of complex and computationally intense mathematical or logical functions. For example, the MPEG-1, Part 3 standard utilizes frequency transformation, such as the modified discrete cosine transformation to encode audio data. During decoding, the inverse functions are applied, which are also computationally intense.

Real-time operation is desirable in many audio data applications, wherein the audio data is decoded at approximately, or faster than the audio data is played. Additionally, many audio data applications can include more than one encoded audio data signal. For example, surround sound can include several audio data signals. The foregoing dramatically increase the computational requirements of the audio encoding and decoding hardware.

An audio decoder usually includes a processor that executes firmware. The foregoing is desired for handling other aspects of the audio encoding and decoding in addition to the function computations. However, the processor may not be optimized for performing the specific function computations.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Presented herein are system(s), method(s), and apparatus for an audio decoding accelerator.

In one embodiment, there is presented an audio decoder for decoding audio data. The audio decoder comprises a controller and a computation engine. The controller receives the audio data, and provides parameters, where the parameters are associated with the audio data. The computation engine calculates at least one of a plurality of predetermined functions for said parameters.

In another embodiment, there is presented a method for decoding audio data. The method comprises receiving the audio data; writing parameters associated with the audio data to a memory; and calculating at least one of a plurality of predetermined functions for said parameters.

In another embodiment, there is presented an audio decoder for decoding audio data. The audio decoder comprises a controller and a computation engine. The controller is adapted to receive the audio data, and provide parameters, where the parameters are associated with the audio data. The computation engine is connected to the controller, and adapted to calculate at least one of a plurality of predetermined functions for said parameters.

These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1 is a block diagram describing an exemplary audio decoder in accordance with an embodiment of the present invention;

FIG. 2 is a block diagram describing an exemplary audio encoder in accordance with an embodiment of the present invention;

FIG. 3 is a block diagram describing the encoding of audio data in accordance with the MPEG-1, Part3 standard;

FIG. 4 is a block diagram describing the decoding of audio data in accordance with the MPEG-1, Part 3 standard;

FIG. 5 is a block diagram describing an exemplary audio encoder in accordance with an embodiment of the present invention; and

FIG. 6 is a block diagram describing an exemplary audio decoder in accordance with an embodiment of the present invention.

### DETAILED DESCRIPTION OF THE INVENTION

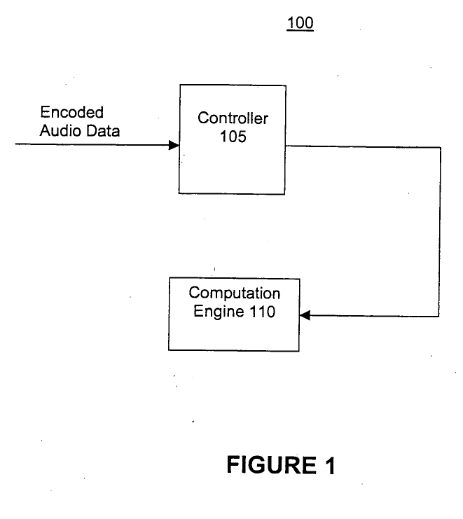

Referring now to FIG. 1, there is illustrated a block diagram of an exemplary audio decoder 100 in accordance with an embodiment of the present invention. The audio decoder comprises a controller 105 for receiving the audio data and providing parameters, and a computation engine 110 for calculating at least one of a number of predetermined functions for the parameters.

The audio decoder 100 receives encoded audio data at the controller 105. To decode the audio data, a number of mathematical or logic functions are performed on portions of the audio data. The process of encoding audio data can include application of mathematical or logic functions. These functions can include, for example, the inverse modified discrete cosine transformation (IMDCT), or the inverse fast Fourier transformation (IFFT), to name a couple. Accordingly, the encoded audio data includes the results of the foregoing functions.

Inverse functions are applied to decode the audio data. The inverse functions can be computationally intense. Accordingly, controller 105 provides the portions of the encoded audio data, parameters upon which the inverse functions (which are also functions) are to be applied. The computation engine 110 applies the functions to the parameters.

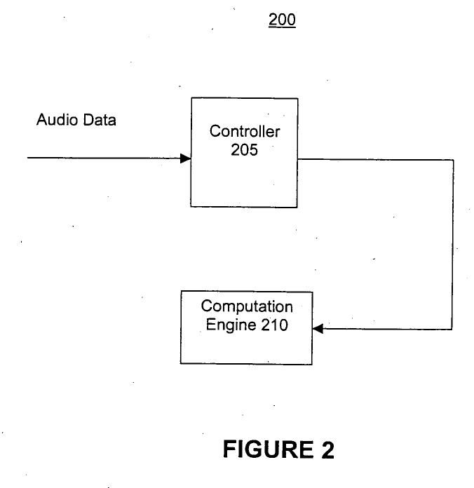

Referring now to FIG. 2, there is illustrated a block diagram of an exemplary audio encoder 200 in accordance with an embodiment of the present invention. The audio encoder comprises a controller 205 for receiving the audio data and providing parameters, and a computation engine 210 for calculating at least one of a number of predetermined functions for the parameters.

The audio encoder 200 receives audio data. The process of encoding audio data can include application of mathematical or logic functions. These functions can include, for example, the modified discrete cosine transformation, or the fast Fourier transformation, to name a couple.

The functions can be computationally intense. Accordingly, controller 205 provides the portions of the audio data, parameters upon which the functions are to be applied. The computation engine 210 applies the functions to the parameters.

Aspects of the present invention can be used with a variety of audio encoding standards. By way of example, embodiments of the present invention will now be described in the context of the MPEG-1, Part 3 standard. Discussion will now turn to a brief description of the MPEG-1, Part 3 standard, followed by exemplary embodiments of the present invention in the context of the MPEG-1, Part 3 standard.

MPEG-1 Part 3

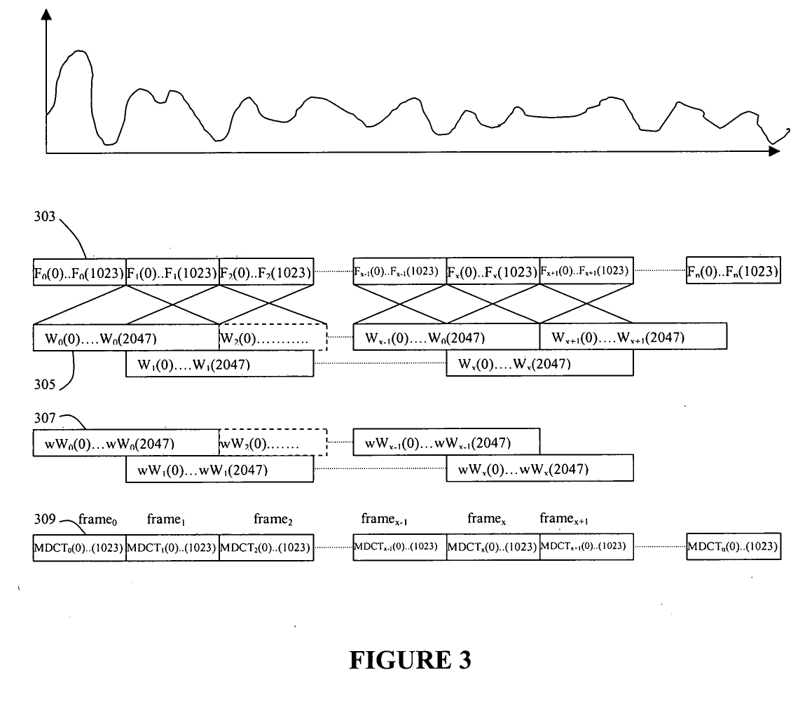

FIG. 3 illustrates a block diagram describing the encoding of an audio signal 301, in accordance with the MPEG-1, Layer 3 standard, MPEG-4 AAC or Dolby Digital AC-3 decoder. The audio signal 301 is captured and used for further audio post processing depending upon the speed. The samples of the audio signal 301 are then grouped into frames 303 (F₀ . . . Fₙ) of 1024 samples such as, for example, (Fₓ(0) . . . Fₓ(1023))

The frames 303 (F₀ . . . Fₙ) are then grouped into windows 305 (W₀ . . . Wₙ) each one of which comprises 2048 samples or two frames such as, for example, (Wₓ(0) . . . Wₓ(2047)) comprising frames (Fₓ(0) . . . Fₓ(1023)) and (Fₓ₊₁(0) . . . Fₓ₊₁(1023)). However, each window 305 Wₓ has a 50% overlap with the previous window 305 Wₓ₋₁. Accordingly, the first 1024 samples of a window 305 Wₓ are the same as the last 1024 samples of the previous window 105 Wₓ₋₁. For example, W₀=(W₀(0) . . . W₀(2047))=(F₀(0) . . . F₀(1023)) and (F₁(0) . . . F₁(1023)), and W₁=(W₁(0) . . . W₁(2047))=(F₁(0) . . . F₁(1023)) and (F₂(0) . . . F₂(1023)). Hence, in the example, W₀ and W₁ contain frames (F₁(0) . . . F₁(1023)).

A window function w(t) is then applied to each window 305 (W₀ . . . Wₙ), resulting in sets (wW₀ . . . wWₙ) of 2048 windowed samples 307 such as, for example, (wWₓ(0) . . . wWₓ(2047)). A Modified Discrete Cosine or Fourier Transform (MDCT/FT) is then applied to each set (wW₀ . . . wWₙ) of windowed samples 307 (wWₓ(0) . . . wWₓ(2047)), resulting sets (MDCT₀ . . . MDCTₙ) of 1024 frequency coefficients 309 such as, for example, (MDCTₓ(0) . . . MDCTₓ(1023)).

The sets of frequency coefficients 309 (MDCT₀ . . . MDCTₙ) are then quantized and coded for transmission, forming an audio elementary stream (AES). The AES can be multiplexed with other AESs. The multiplexed signal, known as the Audio Transport Stream (Audio TS) can then be stored and/or transported for playback on a playback device. The playback device can either be at a local or remote located from the encoder. Where the playback device is remotely located, the multiplexed signal is transported over a communication medium such as, for example, the Internet. The multiplexed signal can also be transported to a remote playback device using a storage medium such as, for example, a compact disk.

During playback, the Audio TS is de-multiplexed, resulting in the constituent AES signals. The constituent AES signals are then decoded, yielding the audio signal. During playback the speed of the signal may be decreased to produce the original audio at a slower speed.

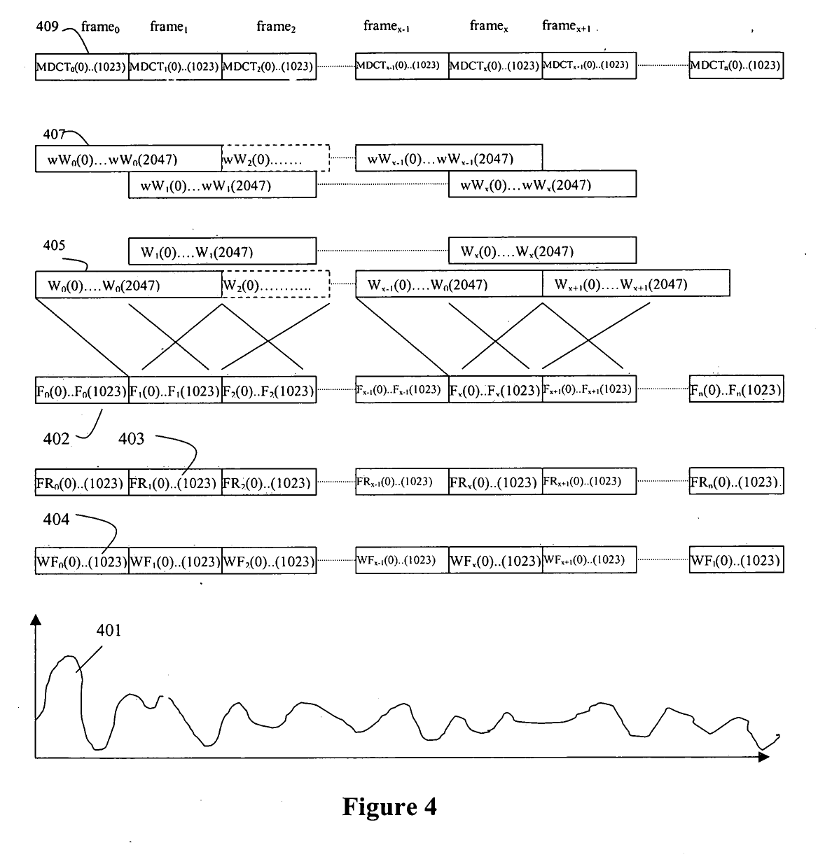

FIG. 4 is a block diagram describing the decoding of an encoded audio signal. The encoded audio signal comprises sets (MDCT₀ . . . MDCTₙ) of 1024 frequency coefficients 409. An inverse modified discrete cosine transform (IMDCT) is applied to each set (MDCT₀ . . . MDCTₙ) of 1024 frequency coefficients 409. The result of applying the IMDCT is the sets (wW₀ . . . wWₙ) of windowed samples 407 (wWₓ(0) . . . wWₓ(2047) equivalent to sets (wW₀ . . . wWₙ) of windowed samples 407 (wWₓ(0) . . . wWₓ(2047)) of FIG. 3.

An inverse window function w_{I}(t) is then applied to each set (wW₀ . . . wWₙ) of 2048 windowed samples 407, resulting in windows 405 (W₀ . . . Wₙ) each one of which comprises 2048 samples. Each window 405 (W₀ . . . Wₙ) comprises 2048 samples from two frames such as, for example, (Wₓ(0) . . . Wₓ(2047)) comprising frames (Fₓ(0) . . . Fₓ(1023)) and (Fₓ₊₁(0) . . . Fₓ₊₁ (1023)) as illustrated in FIG. 3. The frames 403 (F₀ . . . Fₙ) of 1024 samples such as, for example, (Fₓ(0) . . . Fₓ(1023)), are then extracted from the windows 405 (W₀ . . . Wₙ).

A window function WF is then applied to frames 402 (FR₀ . . . FRₘ) to “smooth out” the samples and ensure that the resulting signal does not have any artifacts that may result from repeating each frame. The window function results in the windowed frames 404 (WF₀ . . . WF_{L}) of 1024 samples. The window function WF can be one of many widely known and used window functions, or can be designed to accommodate the design requirements of the system. The windowed frames 404 (WF₀ . . . WF_{L}) of 1024 samples are then run through a digital-to-analog converter (DAC) to get an analog signal 401.

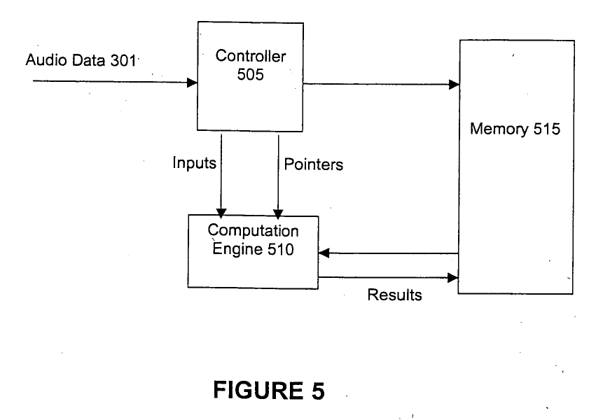

Referring now to FIG. 5, there is illustrated a block diagram describing an exemplary audio encoder 500 in accordance with an embodiment of the present invention. The audio encoder 500 will be described with reference to FIG. 3. The audio encoder 500 comprises a controller 505, a computation engine 510, and memory 515.

The controller 505 is adapted to receive the audio data 301. The audio data 301 comprises samples from an analog signal. As noted above, pursuant to the MPEG-1, Part 3 standard, a wide variety of mathematical and logical functions are performed on the audio data 301 to encode the audio data 301. These functions can include application of a windowing function, the modified discrete cosine transformation, or the fast Fourier transformation.

The computation engine 510 connected to the controller, calculates the appropriate one of the functions on the audio data 301. The computation engine 510 can be a hardware accelerator that is specifically designed for performing the calculations of the mathematical or logical function. According to certain aspects of the present invention, the controller 505 can provide inputs to the computation engine 510 that select the particular function to be performed.

In certain embodiments, a memory 515 connected to the controller can store the audio data 201. The controller 505 can provide pointers to addresses in the memory 515 storing the audio data 301 upon which a particular function is to be performed. Additionally, the computation engine 510 can write the results functions to the memory 515.

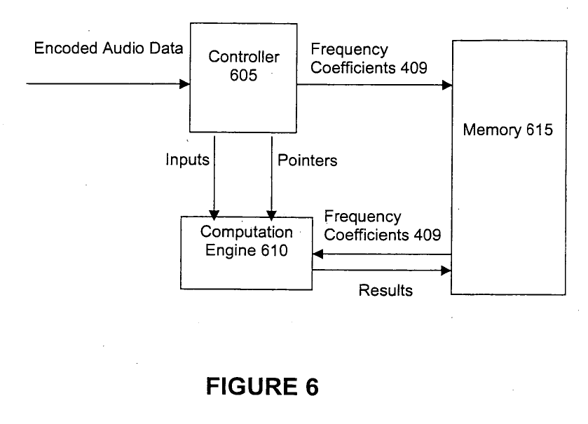

Referring now to FIG. 6, there is illustrated a block diagram describing an exemplary audio decoder 600 in accordance with an embodiment of the present invention. The audio decoder 600 will be described with reference to FIG. 4. The audio decoder 600 comprises a controller 605, a computation engine 610, and memory 615.

The controller 605 receives encoded audio data. The encoded audio data comprises sets (MDCT₀ . . . MDCTₙ) of 1024 frequency coefficients 409. The controller 605 can provide the frequency coefficients 409, as parameters, for application of the inverse modified cosine transformation or inverse fast Fourier transformation.

The computation engine 610 connected to the controller, calculates the appropriate one of the functions on the parameters. The computation engine 610 can be a hardware accelerator that is specifically designed for performing the calculations of the mathematical or logical function. According to certain aspects of the present invention, the controller 605 can provide inputs to the computation engine 610 that select the particular function to be performed.

In certain embodiments, a memory 615 connected to the controller can store the frequency coefficients 409. The controller 605 can provide pointers to addresses in the memory 615 storing the frequency coefficients 409 upon which a particular function is to be performed. Additionally, the computation engine 610 can write the results functions to the memory 615.

In certain embodiments of the present invention, the controller 605 and computation engine 610 can work in parallel. The controller 605 can be preparing the next set of data for the computation engine 610, while computation engine 610 is busy in decoding the current data. With the foregoing parallelism, decoder speed can be increased. Additionally, the foregoing aids the decoding of different standard streams, if scheduling is done on a frame by frame basis. Additionally, in certain embodiments of the present invention, two different audio formats are simultaneous as the computation engines work in parallel. The controller can operate on audio data in a first format, while the controller can operate on audio data in a second format.

The degree of integration of the system will primarily be determined by the speed and cost considerations. Because of the sophisticated nature of modern processor, it is possible to utilize a commercially available processor, which may be implemented external to an ASIC implementation. If the processor is available as an ASIC core or logic block, then the commercially available processor can be implemented as part of an ASIC device wherein certain functions can be implemented in firmware. In one embodiment, the foregoing can be integrated into an integrated circuit. Additionally, the functions can be implemented as hardware accelerator units controlled by the processor.

While the invention has been described with reference to certain embodiments, it will be understood by those skilled in the art that various changes may be made and equivalents may be substituted without departing from the scope of the invention. In addition, many modifications may be made to adapt particular situation or material to the teachings of the invention without departing from its scope. Therefore, it is intended that the invention not be limited to the particular embodiment(s) disclosed, but that the invention will include all embodiments falling within the scope of the appended claims.

1. An audio decoder for decoding audio data, said audio decoder comprising:
a controller for receiving the audio data, and providing parameters, said parameters being associated with the audio data; and
a computation engine for calculating at least one of a plurality of predetermined functions for said parameters.

2. The audio decoder of claim 1, further comprising:
a memory for storing the parameters and results of the said at least one of a plurality of predetermined functions for said parameters.

3. The audio decoder of claim 2, wherein the controller provides pointers to the computation engine, said pointers indicating addresses in the memory that store the parameters.

4. The audio decoder of claim 1, wherein the plurality of predetermined functions comprises an inverse modified discrete cosine transformation.

5. The audio decoder of claim 1, wherein the plurality of predetermined functions comprises a inverse fast Fourier transformation.

6. The audio decoder of claim 1, wherein the controller provides one or more inputs for the computation engine, said one or more inputs selecting the at least one predetermined function from the plurality of functions.

7. The audio decoder of claim 6, wherein the computation engine further comprises:
one or more multiplexers, each of said one or more multiplexers receiving a particular one of the inputs.

8. A method for decoding audio data, said method comprising:
receiving the audio data;
writing parameters associated with the audio data to a memory; and
calculating at least one of a plurality of predetermined functions for said parameters.

9. The method of claim 8, further comprising:
providing pointers indicating addresses in the memory that store the parameters.

10. The method of claim 8, wherein the plurality of predetermined functions comprises an inverse modified discrete cosine transformation.

11. The method of claim 8, wherein the plurality of predetermined functions comprises an inverse fast Fourier transformation.

12. The method of claim 8, further comprising:
providing one or more inputs, said one or more inputs selecting the at least one predetermined function from the plurality of functions.

13. An audio encoder for decoding audio data, said audio encoder comprising:
a controller adapted to receive the audio data and provide parameters, said parameters being associated with the audio data; and
a computation engine connected to the controller, said computation engine adapted to calculate at least one of a plurality of predetermined functions for said parameters.

14. The audio encoder of claim 13, further comprising:
a memory connected to the controller; and
wherein the controller is adapted to write the parameters to the memory.

15. The audio encoder of claim 14, wherein computation engine is adapted to write results of the said at least one of a plurality of predetermined functions for said parameters.

16. The audio decoder of claim 14, wherein the controller is adapted to provide pointers to the computation engine, said pointers indicating addresses in the memory that store the parameters.

17. The audio decoder of claim 13, wherein the plurality of predetermined functions comprises a modified discrete cosine transformation.

18. The audio decoder of claim 13, wherein the plurality of predetermined functions comprises a fast Fourier transformation.

19. The audio decoder of claim 13, wherein the controller is adapted to provide one or more inputs for the computation engine, said one or more inputs selecting the at least one predetermined function from the plurality of functions.

20. The audio decoder of claim 19, wherein the computation engine further comprises:
one or more multiplexers, each of said one or more multiplexers adapted to receive a particular one of the inputs.21. The audio decoder of claim 13, wherein the controller operates on audio data in a first format, while the controller operates on audio data in a second format.
